(19) United States
(12) Patent Application Publication
(10) Pub. No.: US 2010/0175526 A1
(43) Pub. Date: Jul. 15, 2010

(54) HANDS FREE PATTERN CREATING DEVICE

(75) Inventors: Dan Nelson, Bountiful, UT (US); Christopher Henderson, Salt Lake City, UT (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: Making Memories, Centerville, UT (US)

(21) Appl. No.: 12/576,506

(22) Filed: Oct. 9, 2009

Related U.S. Application Data
(60) Provisional application No. 61/104,238, filed on Oct. 9, 2008.

(51) Int. Cl. B26D 5/00; B26D 7/26

(52) U.S. Cl. 83/76.1; 83/821; 83/743

(57) ABSTRACT

A hands free pattern creating apparatus having a hands free securement component which can be utilized to secure a handheld pattern creating device relative a medium upon which the pattern is to be formed. The securement component can include a magnetic component configured to be secured to the hands free securement device such as magnetic tabs, a elongate member or a removable collar having magnetic or metallic components secured thereto. A pattern or design surface or mat having metallic or magnetic properties such that the magnetic component provides a desired amount of magnetic attraction when positioned on media positioned on the pattern mat to minimize movement of components pattern creating device during creation of the pattern on the media, but allowing the user to remove and/or reposition the pattern cutting device relative to the pattern mat once the pattern has been completed.

### CROSS REFERENCE TO RELATED APPLICATIONS

This application claims the benefit of U.S. Provisional Patent Application No. 61/104,238, filed on Oct. 9, 2008, the entire contents of which are herein incorporated by reference.

### BACKGROUND OF THE INVENTION

1. Field of the Invention

The present invention is directed to a hands free securement device. In more particular the present invention is directed to a hands free securement device adapted to secure on a support surface a mechanism that is adapted to draw, illustrate, emboss, engrave, or cut a receptive media such as paper, corkboard, wood, stone or the like and on which the mechanism is positioned.

2. Relevant Technology

A variety of digital design cutting mechanisms have been developed in recent years which are adapted to provide automated cutting of shapes, letters, and designs on paper or other suitable media without requiring the tedious tracing and cutting of such designs by the user. Such mechanisms are adapted such that a digital image is stored in the memory of the digital design cutting mechanism and an automated system cuts such digital design into the paper or other cutting medium. Many such mechanisms are assembled much like a computer printer. A user feeds the paper, corkboard or other media to be cut into a feeding slot on the side of the machine. The digital design cutting mechanism then automatically fed the medium and cutting of the medium is carried out. The drawback of such printer-like digital design cutting mechanisms is that the digital design cutting mechanisms tend to be fairly large. As a result, the user will typically be limited to using such device in their home or office as such devices do not lend themselves to easy portability. Additionally, it can be difficult to estimate where on the paper such cutting will be implemented. As a result, large amounts of paper can be wasted, and/or complicated and non-intuitive routines to reposition the cutting location on such paper can result.

One digital design cutting mechanism which has been developed provides a substantially self-contained and portable handheld design. The handheld pattern creating device can be placed directly upon a paper or other media to be cut and cutting is conducted directly onto the media. This digital design cutting mechanism employs an electronic cutting device that allows a user to select from a number of preloaded images that can be chosen as a particular design and which can be cut utilizing the digital design cutting mechanism. The user then positions the digital design cutting mechanism at a desired position on the paper. Typically a secondary cutting mat such as tempered glass or other hard material is positioned beneath the paper or medium to be cut. Once the digital design cutting mechanism is in the desired position on the paper, the user then pushes a button to begin the automated cutting process. During the automated cutting process the user uses his or her hands to secure the digital design cutting mechanism relative to the medium to be cut to ensure reliable and uniform cutting of the medium. While the ability to position the digital design cutting mechanism on the cutting mat and/or over the media to be cut represents a significant advancement over known technologies, some users may desire to turn their attention to other aspects of a project instead of using one or both hands to secure the digital design cutting mechanism during the cutting process.

One device that has been implemented is a receptive framework into which the digital design cutting mechanism may be mounted. The framework is configured such that the position of the digital design cutting mechanism on the cutting mat may be adjusted while still allowing securement of the digital design cutting mechanism relative to the mat. The deficiency of such framework or mounting device is that it can be cumbersome and non-intuitive. It may be difficult and time consuming for the user to position the digital design cutting mechanism at an exact location on the cutting surface. Additionally, the framework design may be cumbersome to use, limit the number of positions or juxtapositions of the digital design cutting mechanism relative to the paper, or may otherwise detract from the experience of utilizing the digital design cutting mechanism. In one illustrative example, the mere bulk and size of the framework represents yet another component that would need to be transported in the event that a user desires to utilize the digital design cutting mechanism outside of the typical home or office setting. Additionally, the components of the framework may lend themselves to damage, wearing, or unexpected failure at inopportune moments.

### BRIEF DESCRIPTION OF THE DRAWINGS

FIG. 1A a perspective view of a handheld pattern creating device according to one aspect of the present invention.

FIG. 1B illustrates the handheld pattern creating device of FIG. 1A positioned on a the surface of a medium to be cut, according to one embodiment of the present invention.

FIG. 1C illustrates the handheld pattern creating device of FIG. 1A in which a shape has been cut out from a piece of paper positioned on a cutting mat, according to one embodiment of the present invention.

FIG. 2A is a perspective view of illustrative embodiment of a handheld pattern creating device having a hands free securement device for securing the handheld pattern cutting device relative to a cutting mat.

FIG. 2B is a perspective view of the handheld pattern creating device of FIG. 2A being utilized with a device securement mechanism of a hands free securement device.

FIG. 2C is a perspective view of the handheld pattern creating device of FIG. 2A with the hands free securement device securing the handheld pattern creating device relative to the medium to be cut and the cutting surface, according to one embodiment of the present invention.

FIG. 2D is a perspective view of the handheld pattern creating device of FIG. 2A in which the pattern creating device has been utilized to form a cutout shape from a piece of paper.

FIG. 3 is a perspective view of a handheld pattern creating device in which the hands free securement device includes integrated magnets integrally coupled to the housing of the pattern creating device.

FIG. 4 illustrates a handheld pattern creating device for use with a cutting mat having integrated magnetic or metallic components positioned on the cutting surface.

FIG. 5 is a perspective view of a handheld pattern creating device adapted to receive a magnetic flange, which is positioned on the underside of the housing of the handheld pattern creating device.

FIG. 6 is a perspective view of a handheld pattern creating device having a hands free securement device comprising a actuatable mechanism, which raises and lowers magnetic components so as to allow the removal of the magnetic force without needing to move or reposition the pattern creating device.

### BRIEF SUMMARY OF THE INVENTION

The present invention relates to a pattern creating device having a hands free securement component or a hands free securement device to secure the pattern creating device relative to a medium upon which the pattern is to be formed. According to one embodiment of the present invention, the hands free securement device comprises a magnetic component configured to be secured to the hands free securement device. Additionally, the hands free securement device can include a pattern mat having metallic or magnetic properties such that the magnetic component provides a desired degree of magnetic attraction to the cutting mat. As a result, when the pattern creating device is positioned on the cutting mat, the magnetic component secures the pattern creating device relative to the media positioned on the cutting mat. As a result, any unintentional or undesired movement of the pattern creating device relative to the media is minimized. This can be helpful when components of the pattern creating device such as a drive mechanism are moving during the creation of a pattern on the media. The hands free securement device allows the user to remove and/or reposition the pattern creating device relative to the pattern mat once the pattern has been completed.

According to one embodiment of the present invention the magnetic force provided by one or both of the magnetic component and the cutting mat is designed to provide the minimal amount of force needed to prevent movement of the pattern creating device while also permitting a desired removal and repositioning of the pattern creating device once the pattern has been formed. According to one embodiment of the present invention, the hands free securement device can be utilized in connection with the pattern creating device to draw, illustrate, emboss, engrave, cut or otherwise form patterns in connection with desired media such as paper, corkboard, leather, metal, stone or other surfaces upon which or from which a pattern can be formed.

### DETAILED DESCRIPTION

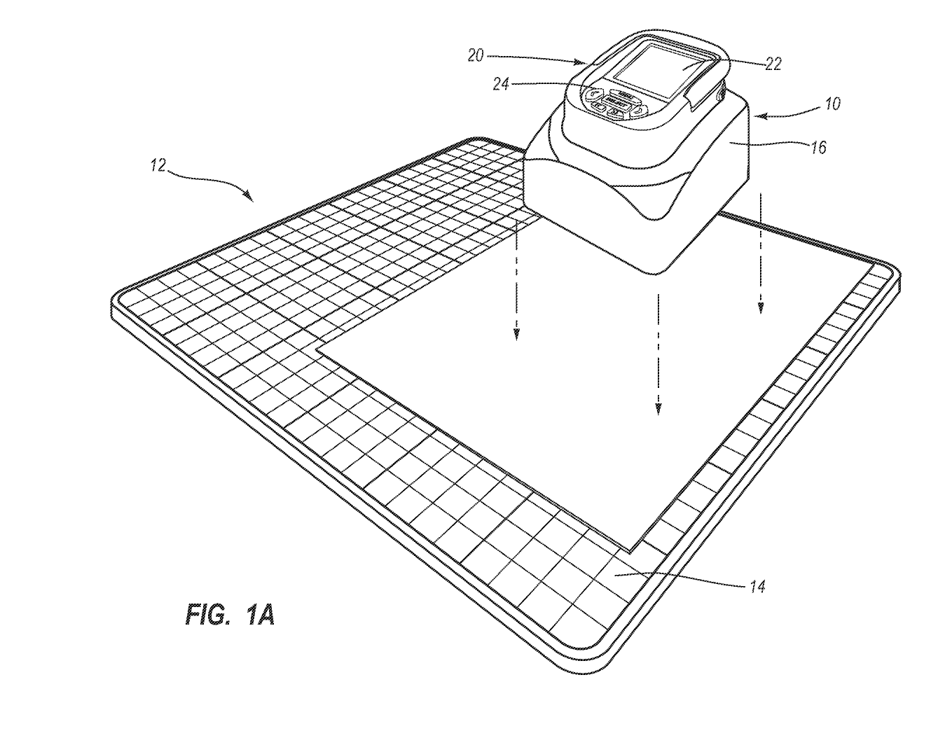

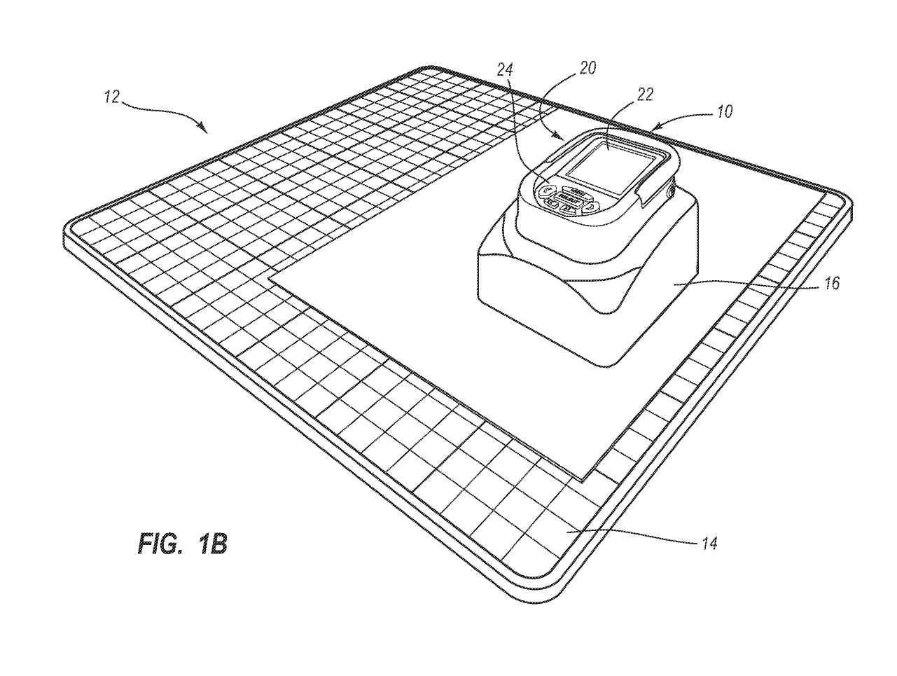

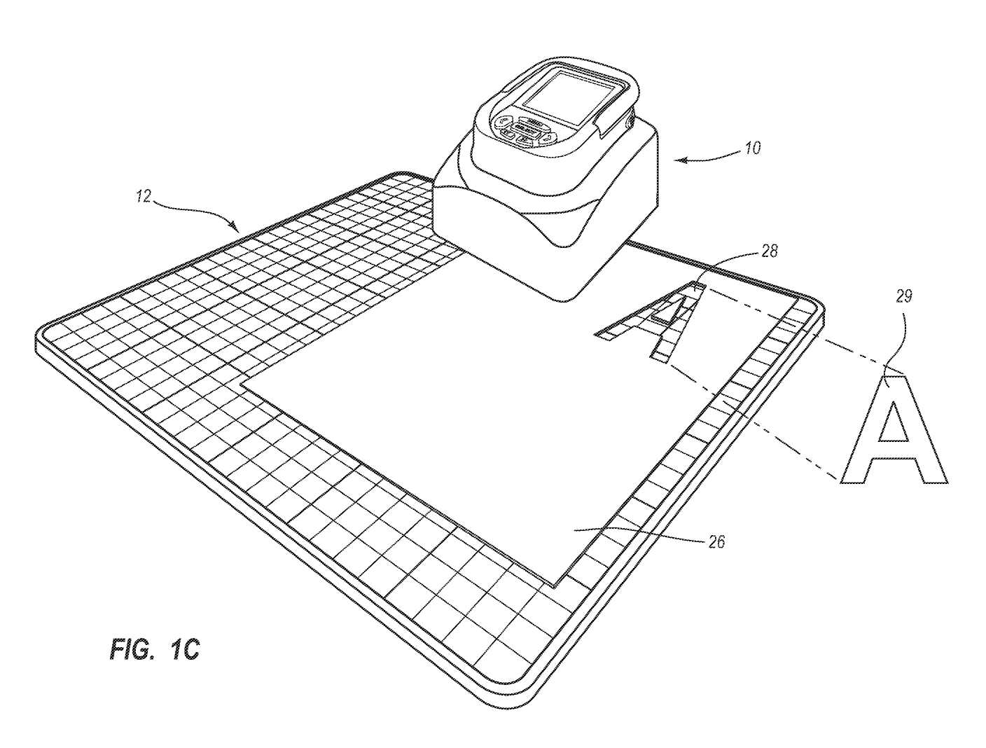

FIG. 1A is a perspective view of a handheld pattern creating device 10 according to one embodiment of the present invention. Handheld pattern creating device 10 is adapted to allow a user to automatically form images and/or patterns in a media. For example, in the illustrated embodiment the handheld pattern creating device comprises a digital design cutting mechanism. The digital design cutting mechanism is utilized to cut shapes from paper on which the digital design cutting mechanism is positioned. As a result, the user is not required to use multiple stamps, presses or other devices which have traditionally been utilized to form individual patterns. Additionally, the handheld pattern creating device 10 is not limited to formation of a single image having a single size, but rather can form images of a large number of shapes, sizes, and designs, which can be uploaded into the handheld pattern creating device 10.

In the illustrated embodiment, a cutting mat 12 is provided in connection with the handheld pattern creating device 10. The cutting mat 12 comprises a sheet of tempered glass with superimposed gridlines imposed on its upper surface. The tempered glass material from which cutting mat 12 is formed provides a uniform and reliable cutting surface 14 upon which patterns can be cut, drawn, illustrated, embossed or engraved. The grid placed on the cutting surface 14 allows the user to approximately determine the desired location of paper or other media which are to be placed upon the cutting mat 12.

In the illustrated embodiment, handheld pattern creating device 10 includes a housing 16, and an electronic cutting device 20. Electronic cutting device 20 includes a display screen 22 and a controller mechanism 24. Display screen 22 depicts menu options and a variety of different image sizes, shapes and designs which can be selected by the user to different patterns utilizing handheld pattern creating device 10. Controller mechanism 24 comprises a plurality of buttons that allow a user to toggle between selections on the display screen and provide desired functionality of the electronic cutting device 20. Housing 16 encloses components of the handheld pattern creating device 10. Housing 16 includes a lower rim 18. In the illustrated embodiment, lower rim 18 is adapted to be positioned on or adjacent cutting surface 14 during operation of handheld pattern creating device 10.

According to one embodiment of the present invention, electronic device 20 comprises a graphical user interface that enables a user to select one or more digital designs to be formed upon the desired media. A drive mechanism is utilized to provide desired movement of a pattern creating implement based on information stored in the graphical interface. The drive mechanism is adapted to provided forward, backward and rotational movement as desired or as needed to form desired patterns on the digital media. The drive mechanism of the handheld pattern creating device 10 is positioned within housing 16 such that when the lower rim 18 is positioned on cutting surface 14 the pattern creating implement can be positioned upon the paper or other media which has been placed upon cutting surface 14.

As will be appreciated by those skilled in the art, a variety of types and configurations of handheld pattern creating devices can be utilized without departing from the scope and spirit of the present invention. For example, according to one embodiment of present invention the handheld pattern creating device does not include an internal graphical user interface, but rather is connected to an external computer which can store or transmit images to the pattern creating device. According to another embodiment of the present invention, external components such as a graphical user interface from a computer comprise a portion of the pattern creating device. According to another embodiment of the present invention, the pattern creating device can comprise a cutting device, a drawer, an illustrator, an embossing mechanism and/or an engraving mechanism. According to another embodiment of the present invention, the housing does not enclose all or many of the components of the handheld pattern creating device, but rather the housing comprises a framework adapted to be positioned adjacent the cutting surface of the cutting mat.

FIG. 1B illustrates the handheld pattern creating device 10 positioned upon cutting mat 12. In the illustrated embodiment, a sheet of paper 26 is positioned between cutting mat 12 and handheld pattern creating device 10. The design of handheld pattern creating device 10 permits the user to select any portion of the paper 26 upon which to place handheld pattern creating device 10. In this manner, in the event that cut-outs or pattern have been formed in other portions of paper 26 the handheld pattern creating device can easily be positioned on portions of the paper 26 which remain unused. In the illustrated embodiment, once the user has positioned the handheld pattern creating device 10 upon paper 26, the user can actuate pattern creation utilizing one or both of display screen 22 and controller mechanism 24 of electronic cutting device 20. In the illustrated embodiment, configuration of handheld pattern creating device 10 is such that the user will grasp the handheld pattern creating device 10 to limit movement of handheld pattern creating device 10 during the creation of the pattern. Once the pattern has been created, the user may then remove or reposition the handheld pattern creating device 10 and form additional patterns utilizing paper 26.

FIG. 1C illustrates a shape 29 which has been formed in paper 26 utilizing handheld pattern creating device 10. In the illustrated embodiment, handheld pattern creating device 10 comprises a digital design cutting mechanism. As a result, the pattern formed utilizing paper 26 comprises a cut-out 28 in a corresponding shape 29. In the illustrated embodiment, a user has selected the letter ‘A’ which has been cut-out from paper 26. According to one embodiment of the present invention, the size shape and even script of the font utilized to form shape 29 may be varied utilizing the handheld pattern creating device 10. Because a cut-out 28 has been formed in paper 26, the user will reposition handheld pattern creating device 10 on a different portion of paper 26 before forming another shape. For example, in the even that the user desires to cut-out a different shape such as a small cut-out animal or a flower, the user can select the desired digital design, place handheld pattern creating device 10 on the left hand side of paper 26 or lower on the right side of paper 26 and then actuate handheld pattern creating device 10. In this manner, an additional shape or cut-out can be formed utilizing an unused portion of paper 26.

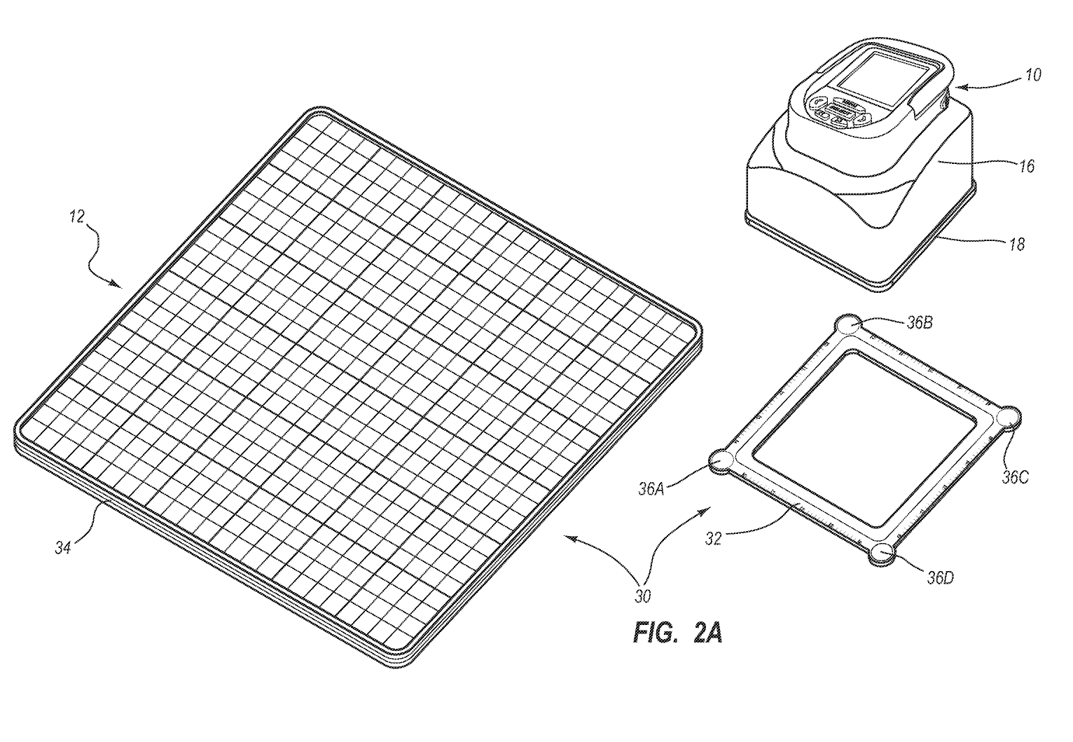

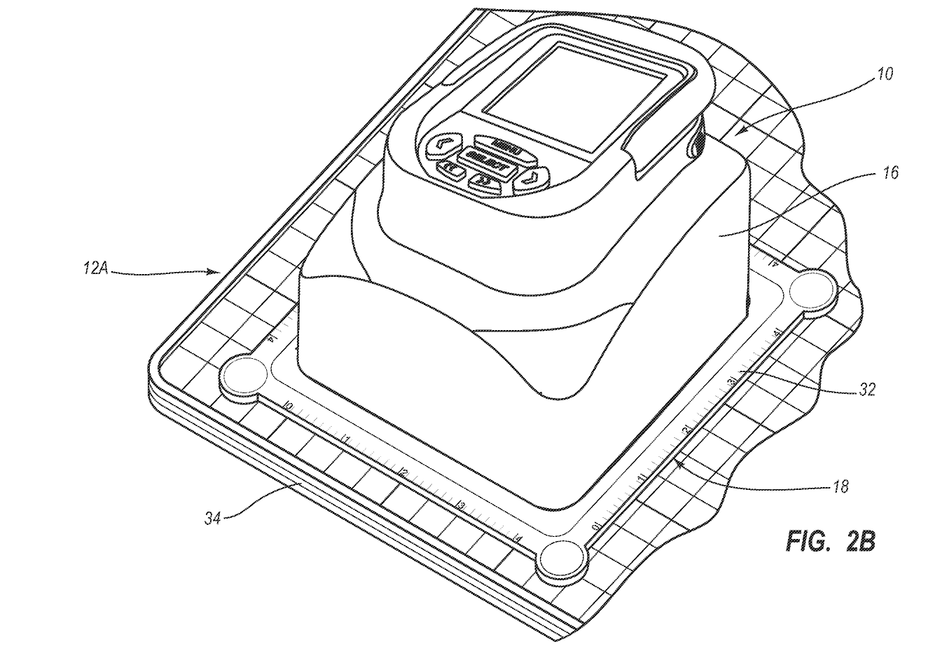

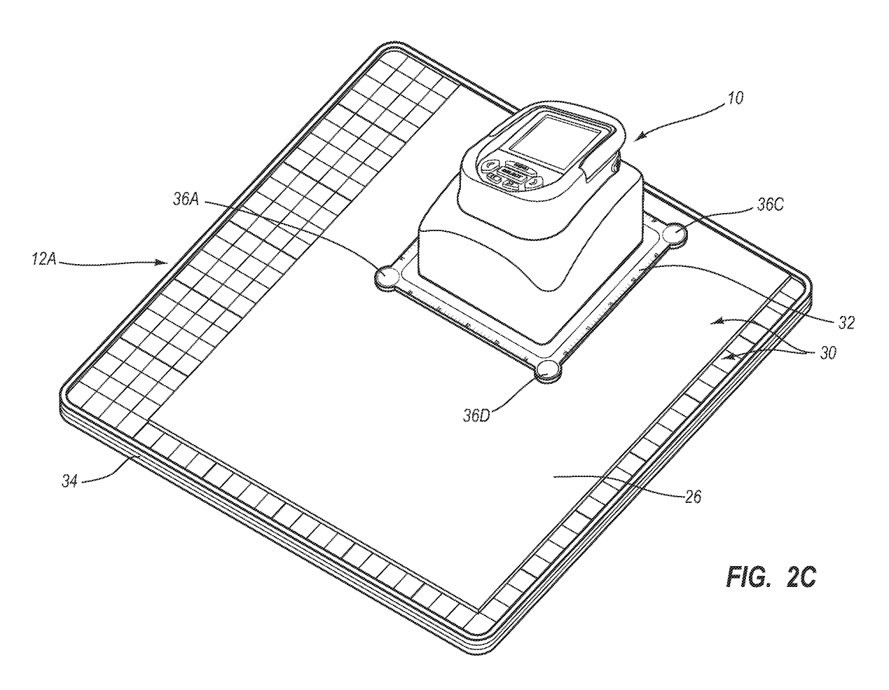

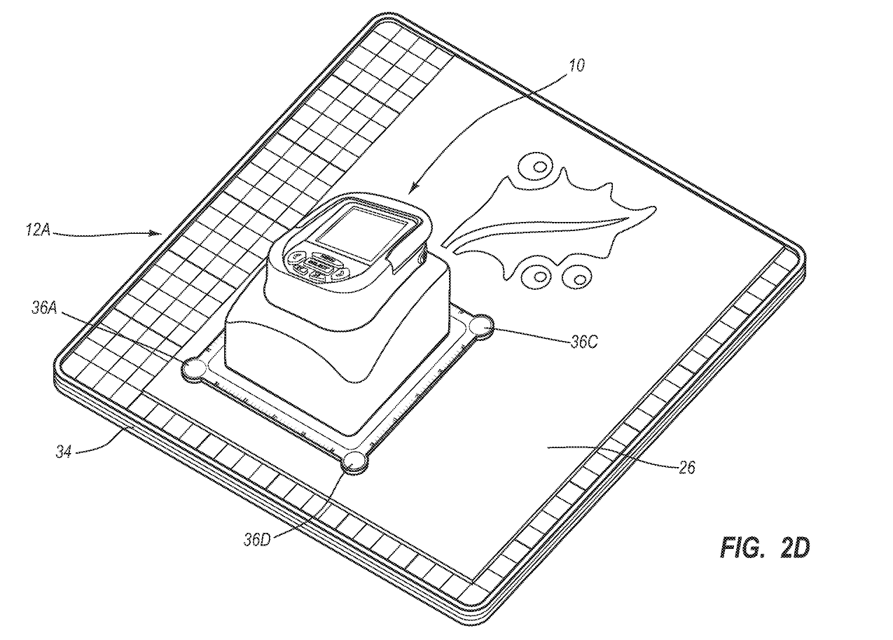

FIG. 2A is a perspective view of a handheld pattern creating device 10 having a hands free securement device 30 for securing the position of the handheld pattern creating device relative to a cutting mat 12A in a simple and hands free manner. By utilizing a hands free securement device 30, the user can turn their attention to other tasks to be performed without needing to worry about undesired movement of the handheld pattern creating device 10 during operation.

In the illustrated embodiment, hands free securement device 30 comprises a device securement mechanism 32 and a cutting surface securement component 34. Device securement controller mechanism 24 comprises a ring which can be positioned around housing 16 of handheld pattern creating device 10. The configuration of device securement mechanism 32 is such that the device securement mechanism 32 is securely coupled to housing 16 such that the lower rim 18 of handheld pattern creating device is held in a fixed positioned relative to a cutting surface of cutting mat 12A. in the illustrated embodiment, device securement mechanism 32 includes a plurality of magnetic components 36A, B, C, D, positioned at each of the respective corners of the device securement mechanism 32. According to one embodiment of the present invention, device securement mechanism can be added or removed from the handheld pattern creating device 10 as desired by the user to provide desired functionality.

In the illustrated embodiment, cutting mat 12A comprises a glass or plastic cutting surface. An embedded metallic layer 34 is positioned within or beneath the portion of cutting mat 12A comprising the glass or plastic cutting surface. The magnetic attraction provided between device securement mechanism 32 and the embedded metallic layer 34 provides sufficient magnetic attraction to secure handheld pattern creating device 10 relative to cutting mat 12A even when paper or other material is interposed there between. According to one embodiment, the metallic layer is provided so as to be superimposed on other portions of the cutting mat 12A.

As will be appreciated by those skilled in the art, a variety of types and configurations of hands free securement devices can be provided without departing from the scope and spirit of the present invention. For example, in one embodiment a plurality of slots can be provided on the housing or other portions of the handheld pattern cutting device which receive magnetic implements to secure handheld pattern creating device 10 relative to cutting mat 12A. According to another embodiment of the present invention, the magnetic portions of hands free securement device 30 are integrally coupled to handheld pattern creating device 10. According to another embodiment of the present invention, an additional magnetic component is provided on the cutting mat while an additional magnetic or cutting component is provided on the handheld pattern creating device. According to yet another embodiment on the present invention, metallic components are provided on the handheld pattern creating device and magnetic components are provided on the cutting mat.

FIG. 2B illustrates the handheld pattern creating device 10 of FIG. 2A. In the illustrated embodiment, handheld pattern creating device 10 has been secured with device securement mechanism 32. In this manner, movement of handheld pattern creating device 10 results in movement of device securement mechanism 32. The device securement mechanism 32 fits around the body of housing 16. The lower rim 18 provides an abutting surface which secures the position of device securement mechanism 32 relative to the other portions of handheld pattern creating device 10. As the user begins to move handheld pattern creating device 10 closer to cutting mat 12A, the magnetic attraction between device securement mechanism 32 and the cutting surface securement component 34 of cutting mat 12A begin to interact. As a result, this allows for positioning of handheld pattern creating device 10 relative to cutting mat 12A without requiring the user to hold handheld pattern creating device 10 in position.

FIG. 2C illustrates utilization of hands free securement device 30 in connection with handheld pattern creating device 10 and cutting mat 12A. In the illustrated embodiment, a piece of paper 26 has been positioned between handheld pattern creating device 10 and cutting mat 12A. The magnetic components 36A, B, C, D (magnetic component 36B not shown) interact with cutting surface securement component 34 securing handheld pattern creating device 10 relative to cutting mat 12A. As the components of handheld pattern creating device 10 begin to form an image, such as cutting the paper 26, the magnetic attraction between magnetic components 36A, B, C, D and cutting mat 12A limit or eliminate completely any moving of handheld pattern creating device 10. In this manner, a user can turn their attention or perform other aspects of the project they are working on without needing to hold handheld pattern creating device 10 in position.

FIG. 2D illustrates the handheld pattern creating device 10 of FIGS. 2A depicting the manner in which handheld pattern creating device can be removed from cutting mat 12A once a cut-out image has been formed in paper 26 while allowing repositioning of the handheld pattern creating device 10 once a first shape has been formed.

In the illustrated embodiment, the first shape comprises a cut-out or illustration that is positioned on an upper portion of the sheet of paper. To reposition handheld pattern creating device 10, the user simply grasps the housing portion of the handheld pattern creating device 10 and urges handheld pattern creating device 10 in a direction away from cutting matt 12. When sufficient force is exerted on handheld pattern creating device 10 to overcome the magnetic forces holding handheld pattern creating device 10 in position relative to the cutting mat 12, handheld pattern creating device 10 can be removed and repositioned relative to paper 26 and/or cutting mat 12.

In the illustrated embodiment, the handheld pattern creating device 10 has been repositioned to a lower portion of the paper which does not have a pattern formed thereon. Utilizing handheld pattern creating device 10 it is simple and efficient for a practitioner to form shapes and optimize use of the paper without requiring the use of complicated printer type cutout machines which tend to waste paper or require complicated electronic controls or require a bracket securement systems which tend to be non-intuitive. Instead, the user can easily identify a target location on a piece of cutout/design media, place handheld pattern creating device 10, input design instructions into the user interface of handheld pattern creating device 10 and allow handheld pattern creating device 10 to form the cutout/design while the user can turn his/her attention to other aspects of the procedure to be performed.

FIG. 3 illustrates a handheld pattern creating device having integrated magnetic attraction components 38a-d. In the illustrated embodiment, the integrated magnetic attraction components 38a-d can comprise magnets or metallic members which are configured to cooperate with magnetic components of cutting mat, or combination of both.

In the illustrated embodiment the underside of an illustrative handheld pattern creating device 10 is depicted. Handheld pattern creating device 10 includes a cutting tip 50, a cutting tip positioning component 52, a linear drive 54 and rotational drive 56. Cutting tip positioning component 52 is utilized to move cutting tip 50 along a desired path to form a design or cutout. The illustrated positioning of magnetic attraction components 38a-d in the four corners of handheld pattern creating device 10 provides consistent securement of handheld pattern creating device 10 during cutting or design creation.

As will be appreciated by those skilled in the art, a variety of types and components of positioning mechanisms and design creation mechanisms can be utilized without departing from the scope and spirit of the present invention. For example, according to one embodiment of the present invention, an illustrator tip or embossing tip is utilized in place of a cutting tip. According to another embodiment of the present invention, a positioning mechanism is utilized other than the one depicted.

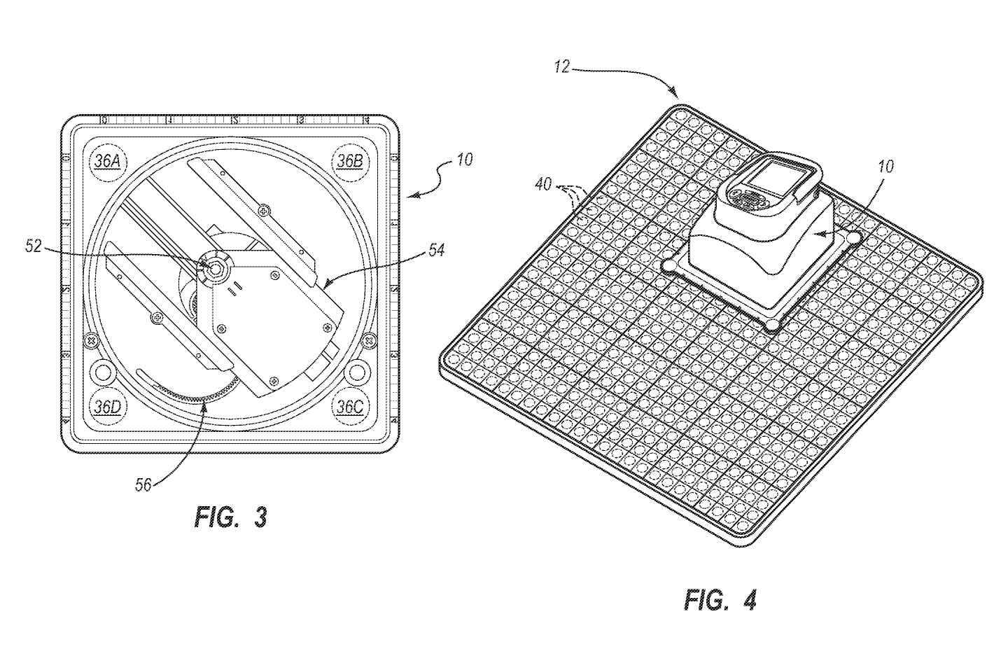

FIG. 4 illustrates a handheld pattern creating device 10 in which magnetic components 40 and/or metallic components have been integrated onto the cutting surface of the cutting mat 12A. In the illustrated embodiment, a plurality of magnetic components 40 are utilized to facilitate securement of handheld pattern creating device 10 to cutting mat 12. According to one aspect of the present invention magnetic components 40 comprise rare earth or other magnet attraction components. In this embodiment, metal components can be utilized on handheld pattern creating device 10 due to the attraction provided by magnets components 40. In one embodiment, magnets are also used on handheld pattern creating device 10 to increase the attraction of handheld pattern creating device 10 to cutting mat 12.

According to another embodiment of the present invention, magnetic components 40 are metal components which are highly attractive relative to magnetic components utilized on handheld pattern creating device 10. In this manner, the attraction between cutting mat 12 and handheld pattern creating device 10 can be maintained even where a piece of paper or other medium is interposed between handheld pattern creating device 10 and cutting mat 12.

As will be apparent to one skilled in the art, the particular configuration of providing attraction between handheld pattern creating device and the cutting mat can be utilized without departing from the scope and spirit of the present invention. For example, in one embodiment, the cutting surface is metallic or magnetic to provide attraction between handheld pattern creating device and the cutting mat. In another embodiment, a layer of glass is interposed between the metallic component and the magnetic component, or alternatively between two sets of magnetic components. In yet another embodiment, one surface of the cutting mat is metallic and/or magnetic while the opposing side of the cutting mat is glass or another durable smooth surface. In yet another embodiment, the opposing side comprises an embossing surface.

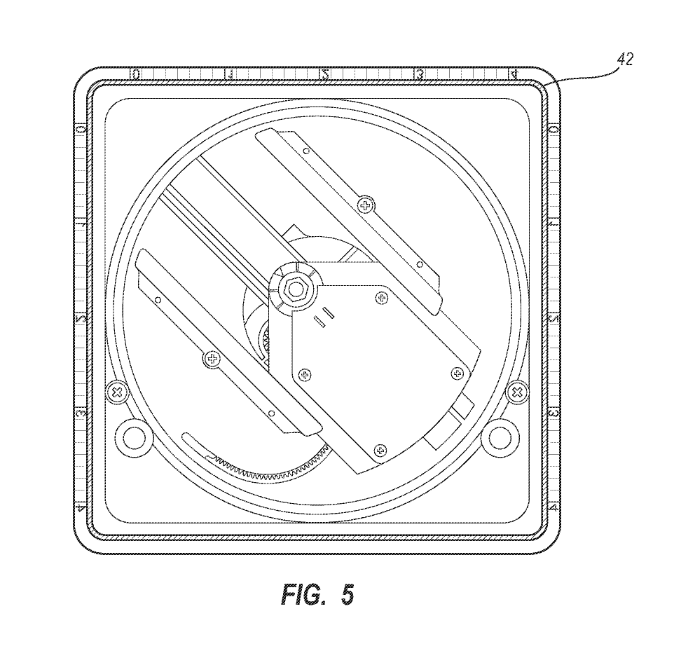

FIG. 5 illustrates a hands free securement device in which a magnetic component 42 is adapted to fit on a groove on the underside of the housing 16 of the handheld pattern creating device 10. In the illustrated embodiment, the magnetic component 42 comprises a rare earth magnetic which is formed into a wire, or elongate member which fits into a groove, flange or other securement feature on the handheld pattern creating device 10. By being positioned on all opposing four sides of housing 16, securement of handheld pattern creating device 10 relative to a cutting mat or other design surface is provided.

The use of magnetic component 42 having an elongate form which fits into groove, provides a simple and unobtrusive mechanism for securing handheld pattern creating device 10 relative to a cutting mat or other design surface. As will be appreciated by those skilled in the art, a variety of types and configurations of handheld pattern creating devices and magnetic components can be utilized without departing from the scope and spirit of the present invention. For example, in one embodiment, the magnetic component is provided in a removable collar which can be optionally secured to the housing of the handheld pattern creating device. According to another embodiment of the present invention, the magnetic component is not positioned as a threaded component around the entire periphery of handheld pattern creating device 10 But rather are interspersed around the outside boundary or positioned on opposing sides of the handheld pattern creating de vice.

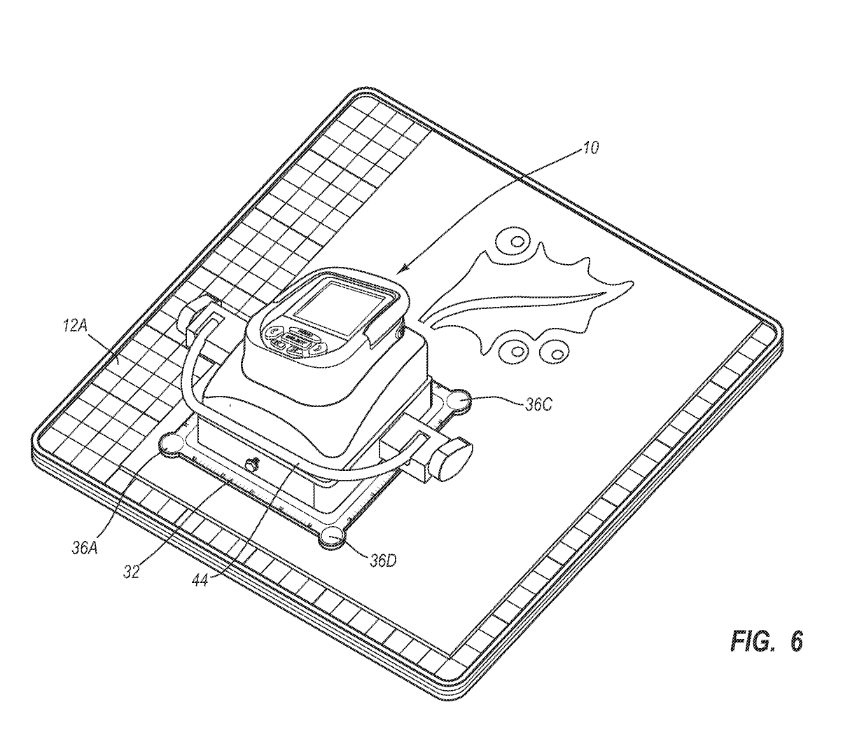

FIG. 6 illustrates a hands free securement device for use with the handheld pattern creating device 10 in which a lever actuated mechanism 44 raises or lowers the magnetic component 36A, B, C, D on the handheld pattern creating device 10 such that magnetic attraction between the device securement mechanism 32 and the cutting mat 12A can be increased, lessened or even removed without needing to move or reposition the handheld pattern creating device.

In the illustrated embodiment, handheld pattern creating device 10 has a lever actuated mechanism which biases between a first position in which magnetic components are positioned adjacent cutting mat 12A and a second position in which magnetic components are positioned further away from cutting mat 12A. In this manner, the user can increase or lessen the magnetic attraction between handheld pattern creating device 10 and cutting mat 12A without having to displace handheld pattern creating device 10 relative to cutting mat 12A. In this manner, a simple and effective mechanism is provided to allow simple removal and repositioning of handheld pattern creating device 10.

For example, in a first step, a user places a handheld pattern creating device 10 adjacent cutting mat 12A. In a second step, the user biases the lever handle from a first position to a second position to increase the magnetic attraction between handheld pattern creating device 10 and cutting mat 12A. In a third step, the user actuates the handheld pattern creating device 10 to form a design on a medium such as paper. In a fourth step, the user biases the lever handle from the second position to the first position to decrease the magnetic attraction between handheld pattern creating device 10 and the cutting mat 12A. In a fifth step, the user removes or repositions handheld pattern creating device 10 relative to the cutting mat 12A.

As will be appreciated by those skilled in the art, a variety of types and configurations of handheld pattern creating device can be utilized without departing from the scope and spirit of the present invention. For example, in one embodiment, a component other than a lever handle is utilized to increase or decrease the amount of magnetic attraction between handheld pattern creating device and a design surface without having to remove or reposition the handheld pattern creating device. In another embodiment, the lever actuated or magnetic increase/decrease mechanism comprises a removable component that can be selectively secured relative to handheld pattern creating device. According to another embodiment of the present invention, the lever handle and magnetic component are separate components. In yet another embodiment, they form part of the same removable mechanism.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A pattern creating device having a hands free securement component, the hands free securement component configured to secure the pattern creating device relative a medium upon which the pattern is to be formed, the pattern device comprising:
a graphical user interface for storing one or more digital designs to be formed upon a desired media;
a pattern creating implement adapted to transfer the digital design to the desired media;
a drive mechanism linked to the pattern creating implement, movement of the drive mechanism being controlled based upon the digital designs stored in the graphical interface;
a housing for securing one or more of the graphical user interface, the pattern creating implement and the drive mechanism;
a hands free aligner comprising a magnetic device (integrally coupled to the housing, removably coupled) linked to the housing or another portion of the pattern creating device allowing the pattern creating device to be secured to a surface having magnetic or metallic properties such that the pattern creating device is held in place relative to the media during formation of the pattern.

2. The pattern creating device of claim 1, wherein the hands free aligner is integrally coupled to the other components of the pattern creating device.

3. The pattern creating device of claim 2, wherein the hands free aligner is coupled to the housing of the pattern creating device.

4. The pattern creating device of claim 3, wherein the magnetic components of the hands free aligner are positioned on the underside of the pattern creating device so as to be in contact with a design surface.

5. The pattern creating device of claim 4, wherein the magnetic components comprise magnetic components positioned on four corners of the pattern creating device.

6. The pattern creating device of claim 4, wherein the magnetic components comprises an elongate threaded component positioned around the outer periphery of the underside of the housing.

7. The pattern creating device of claim 6, wherein the elongate threaded component is positioned within a groove on a flange of the housing.

8. The pattern creating device of claim 1, wherein the hands free aligner is removably coupled to the other components of the pattern creating device.

9. The pattern creating device of claim 8, wherein the hands free aligner comprises a removable collar which can be selectively secured to the pattern creating device.

10. A hands free securement device configured to secure a pattern creating device at a desired position relative to a medium upon which the pattern is to be imposed, the hands free securement device comprising
a magnetic component configured to be secured to the hands free securement device;
a pattern mat having metallic or magnetic properties such that the magnetic component provides a desired amount of magnetic attraction when positioned on media positioned on the pattern mat to minimize movement of components pattern creating device during creation of the pattern on the media, but allowing the user to remove and/or reposition the pattern cutting device relative to the pattern mat once the pattern has been completed.

11. The hands free securement device of claim 10, wherein the magnetic component comprises a collar having magnetic components secured thereto.

12. The hands free securement device of claim 11, wherein the magnetic components comprise magnets.

13. The hands free securement device of claim 11, wherein the magnetic components comprise metallic components.

14. The hands free securement device of claim 11, further comprising a lever handle which can be utilized to increase or decrease the amount of magnetic attraction between the hands free securement device and a design surface.

15. The hands free securement device of claim 14, wherein the lever handle has a first position and a second position.

16. The hands free securement device of claim 15, wherein the first position results in a decreased amount of attraction to the design surface and the second position results in an increased amount of attraction to the design surface.

17. The hands free securement device of claim 14, wherein the lever handle allows the user to increase or decrease the amount of magnetic attraction between the hands free securement device and the design surface without having to move or lift the hands free securement device.

18. A hands free pattern creating apparatus having a hands free securement component, the hands free securement component configured to secure a handheld pattern creating device relative a medium upon which the pattern is to be formed, the hands free pattern creating apparatus comprising
a handheld pattern creating device comprising:
a graphical user interface for storing one or more digital designs to be formed upon a desired media;
a pattern creating implement adapted to transfer the digital design to the desired media;
a drive mechanism linked to the pattern creating implement, movement of the drive mechanism being controlled based upon the digital designs stored in the graphical interface;
a housing for securing one or more of the graphical user interface, the pattern creating implement and the drive mechanism;
a hands free aligner comprising a securement component linked to the housing or another portion of the pattern creating device allowing the pattern creating device to be secured relative to a cutting surface such that the pattern creating device is held in place relative to the medium during formation of the pattern; and
a cutting mat comprising a cutting surface, wherein the cutting mat and securement component of the hands free aligner of the hands free pattern creating device interact magnetically to secure the pattern creating device relative to the cutting mat and the medium on which the pattern is to be formed.
